(19) United States
(12) Patent Application Publication
(10) Pub. No.: US 2010/0174992 A1
(43) Pub. Date: Jul. 8, 2010

(54) SYSTEM AND METHOD FOR SCREEN RECORDING

(76) Inventors: Leon PORTMAN, Rishon Lezion (IL); Nir Zigler, Moshav Beherothim (IL)

Correspondence Address: Pearl Cohen Zedek Latzer, LLP, 1500 Broadway, 12th Floor, New York, NY, 10036, US

(21) Appl. No.: 12/348,300

(22) Filed: Jan. 4, 2009

(51) Int. Cl. G06F 3/00

(52) U.S. Cl. 715/738

(57) ABSTRACT

Embodiments of the inventions are directed to a method for recording screen data. The method may include receiving display data displayed on a local screen coupled to a local computing device wherein the display data originate from first and second applications executed on first and second remote application servers; receiving layout data related to a presentation of the display data on the local screen; and reconstructing visual appearance of the presentation based on the layout information and the display data.

### BACKGROUND

The terms screen recording or display recording as used by the industry refer to the capturing and recording of information rendering on a display of a computing device. Screen recording enables replaying sessions, user interactions, applications' output and/or other events as reflected by a display of a computing device. Screen recording is widely used in industries and environments such as interaction-related environments, e.g., call or contact centers, banks, academic institutions, government agencies, health care facilities and/or web-based shopping facilities. For example, screen recording may be used by such facilities to produce tutorial sessions, track employees' activities, provide input to risk and/or quality management applications or to obtain documentation and/or proof of events. Regulations and compliance issues may be another reason for the high demand for recording capabilities in systems and applications supporting interaction-related environments. Operators of interaction-related systems may be forced by regulations to record various aspects of their respective systems' operations.

Some current implementations of screen recording use screen recording agents installed on remote application servers. Such screen recording agents may record display data associated with applications executed on the servers on behalf of remote devices, e.g., agents' work stations, thin clients and/or terminals in a contact center. However, such implementations fail to provide a solution for scenarios where a number of remote application servers are associated with a single display session. For example, an agent in a contact center, using a single computing device and a single display, may invoke two separate applications on two separate applications servers. Accordingly, two separate recordings (on the two separate remote application servers) are produced. However, such two applications, and their associated separate recordings may be associated with, or part of, a single display session on the agent's display.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a high-level block diagram of an exemplary screen recording and monitoring system according to embodiments of the present invention;

FIG. 2A shows some a high-level block diagram of an exemplary screen recording system according to some embodiments of the invention;

FIG. 2B shows some a high-level block diagram of an exemplary screen recording system according to some embodiments of the invention;

FIG. 3 is a flowchart diagram illustrating an exemplary flow according to some embodiments of the present invention; and

FIG. 4 shows a high level block diagram of an exemplary computing device that may be used according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing” , “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time.

Although embodiments of the invention are not limited in this regard, the terms “screen recording” and “display recording” should be expansively and broadly construed to include any form of recording of rendering of information on a display screen, or screen for short, of a computing device. For example, display and/or screen recording may refer to the recording of displayed graphical information, displayed textual information, mouse moves, a keyboard's key strokes and/or any other information displayed on a physical display or screen of a computing device. Other events that may be captured and recorded by screen recording may be a turning ON or OFF of a screen, a change of resolution, e.g., number of pixels used for displaying information on the physical display or screen and/or any applicable rendering or other events associated with a display of a computing device.

Although embodiments of the invention are not limited in this regard, the term “display session” should be expansively and broadly construed to include any information rendered on a display during a given time period. A display session may comprise any output displayed on a display as a result of any number of executed applications. Such applications may be executed locally, on a computing device attached to the display associated with the display session or on remote computing devices, e.g., remote application servers. A display session may further comprise any user input or interaction, for example with executed applications as described herein.

An exemplary method according to embodiments of the invention may comprise invoking, from a local computing device, an application on a remote computing device. Such application may display or present display data on a local screen coupled to the local device. The method may further comprise capturing, by the remote computing device, the display data displayed on the local device and capturing, by the local device, layout data associated with a presentation of the display data on the local screen. In some embodiments, the method may comprise sending the layout data and the display data to a recording server and the server may reconstruct, based on the layout data and the display data the presentation of the display data on the local screen.

In some embodiments of the invention a number of remote commuting devices may receive or otherwise obtain display data from a local computing device. For example, a number of remote application servers may collect display data related to a number of applications executed on the remote servers on behalf of an agent's workstation. Collecting of display data as described herein may be done independently by a number of remote servers where each remote server may only collect display data related to applications executed on the specific remote server. Accordingly, display data associated with a local display and collected on a first remote device or server may only contain display information related to applications executed on that first remote device and may contain no information related to applications executed on other remote servers and associated with the same local display. For example, an agent operating a workstation may cause two applications to be executed on two different remote servers where such two applications may display output or any other information on the local, workstation's display.

A module installed on the local device or elsewhere may collect layout data related to the local device's display the terms “layout data” or “display layout data” as used herein may refer to any information, data or metadata usable for recreating or reconstructing a presentation of display data or a display session. For example, layout data may be any data, information or parameters associated with graphical objects rendered on a display. For example, size of specific display windows, a display window's state, e.g., whether a specific display window, box, region object is minimized, in focus, e.g., selected by a user. Other display layout information may be an order (z-axis value) of display windows, e.g., which display window is top most, or whether a first display object completely or partially covers a second displayed object etc. Such information may be required in order to accurately reconstruct a presentation of display data or a display session as viewed on a monitored display or as viewed on a recorded display.

According to embodiments of the invention, display data and layout data may be combined and may be used to recreate or reconstruct a presentation of display data or a display session on a screen of the local device. For example, display data collected by remote application servers and layout data collected as described herein may be sent to a recording device, a replay server and/or a monitoring device. A recording or replay server may combine display data from a number of sources, e.g., a number of remote application servers and layout data and produce a display data stream or other content object that may be readily used to reconstruct, in real time or at a later time, a presentation of display data or a replay of a display session. A recording server or any other suitable server may store such usable display data stream and provide it, upon demand. For example, when an offline replay of a session is required at some later time.

Alternatively, display data and layout data received by a recording server may be stored separately. For example, layout data may be stored in a first file, display data from a first remote application server may be stored in a second file and display data from a second remote application server may be stored in a third file. In such case, combining and/or merging the separate files or sources of display data and layout data may be performed at a later stage. For example, the server storing the data may combine it to a stream upon demand or the server may provide the separate, different files to a replay server that may combine or merge such separate information sources and provide a replay or reconstruction of a presentation of display data or a display session.

It will be realized that merging or combining of a number of display data information or data files or other objects and metadata information may be performed according to any paradigm, algorithm or logic. Merging or combining a number of sources, e.g., a number of display data files and a metadata or layout file into a single display data stream may comprise synchronizing such sources in time.

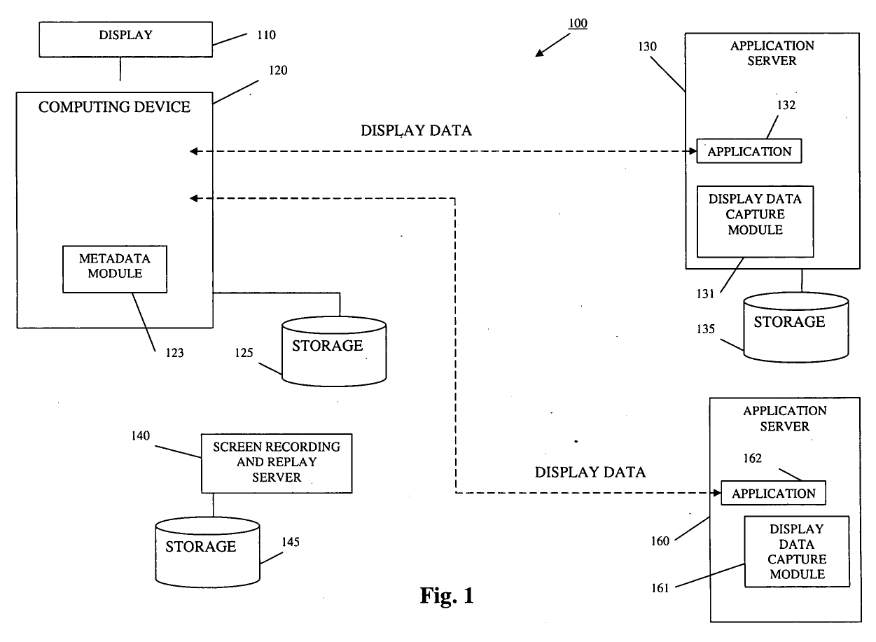

Reference is made to FIG. 1, showing a high-level block diagram of an exemplary screen recording and/or streaming system 100 according to embodiments of the present invention. System 100 may comprise a computing device 120 coupled to a display or screen 110, remote application servers 160 and 130 and a screen recording and monitoring server 140.

Computing device 120 application server 130 and recording server 140 may be connected to storage devices 125, 135 and 145, respectively. Application servers 130 and 160 may comprise display data capture modules 131 and 161 respectively. Computing device 120 may comprise a layout data module 123.

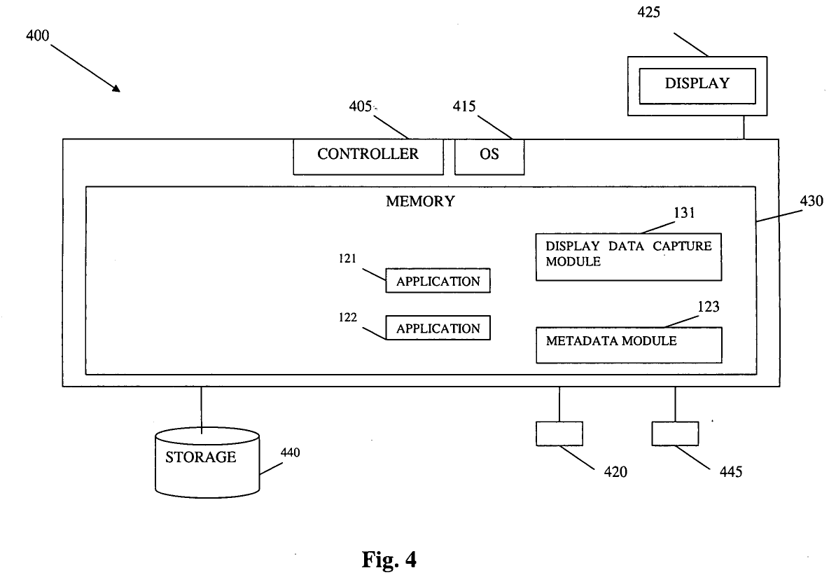

According to embodiments of the invention, computing device 120 may be any applicable computing device and may include or may be, for example, a personal computer, a desktop computer, a mobile computer, a laptop computer, a notebook computer, a terminal, a workstation or a thin client device as known in the art. Remote application servers 130 and 160 and recording server 140 may be any applicable computing device and may include or may be, for example, a personal computer, a desktop computer, a mobile computer, a laptop computer, a notebook computer, a server computer, a tablet computer or any other suitable computing device. Computing device 120, remote application servers 130 and 160 and recording server 140 may be for example, a computing device as described herein with reference to FIG. 4. The terms “computing device”, “computer”, “unit” and “server” as used hereinafter may refer to any applicable computing device such a work station, server or terminal and may be used interchangeably hereinafter.

Computing device 120, servers 130, 160 and recording server 140 may include components such as, but not limited to, a plurality of central processing units (CPU) or any other suitable multi-purpose or specific processors or controllers, a plurality of input units, a plurality of output units, a plurality of memory units, and a plurality of storage units. Computing device 120 servers 130 and 160 and recording server 140 may additionally include any other suitable hardware, software and/or firmware components. It will be recognized that embodiments of the invention are not limited by the nature, type or other aspects of computing device 120, servers 130 and 160 and recording server 140.

According to embodiments of the present invention, computing device 120, remote application servers 160 and 130, and recording server 140 may be connected to a network. Such network may be any suitable network and may enable computing device 120, remote application servers 160 and 130, recording server 140 and any other connected devices to exchange data or information. Screen or physical display 110 may be any suitable display device, unit or system and may be operatively connected to computing device 120. It will be noted that although a single exemplary screen or physical display 110 is shown, device 120 may be operatively connected to a number of displays. According to embodiments of the invention, screen capturing, streaming and/or recording may be applicable to any number of displays connected to a computing device. It will be recognized that embodiments of the invention are not limited by the nature, type or other aspects of screen or physical display 110 nor by the number of display units connected to a computing device, e.g., computing device 120.

According to embodiments of the present invention, recording server 140 may be a dedicated recording device or system comprising dedicated hardware, firmware and/or software or it may be a computing device attached to a suitable storage device or system. Recording server 140 may comprise or may be operatively connected to one or more storage devices such as storage 145. Storage devices 125, 135 and 145 may include, for example, a hard disk drive, a tape drive, a floppy disk drive, a Compact Disk (CD) drive, a CD-Recordable (CD-R) drive, or any other suitable removable and/or fixed storage devices or units. Alternatively or additionally, storage devices 125, 135 and 145 may be or may comprise large storage such as a redundant array of inexpensive drives (RAID) or other large storage capacity devices and/or sub-systems. It will be recognized that embodiments of the invention are not limited by the nature, type or other aspects of storage devices 125, 135 and 145.

According to embodiments of the present invention, remote application servers 130 and 160 may be, for example, servers in a contact or call center running applications on behalf of human agents. For example, an agent operating computing device 120 may invoke applications on remote application servers 130 and/or 160. Servers 130 and 160 may function as remote application servers and may support environments such as virtual desktop and/or remote computing environments. Servers 130 and 160 may further concurrently run a number of applications over a number of operating systems, e.g., Windows™, Linux and/or Mac OS™ possibly by supporting virtual machine technology.

Applications 132 and 162 may be executed on servers 130 and 160 respectively and may further be executed by servers 130 and 160 on behalf of a user operating computing device 120. For example, computing device 120 may only be capable of executing a web browser application or a dedicated user interface application. Accordingly, applications invoked by a user operating computing device 120 may be executed by servers 130 and 160. In such or similar cases, scenarios or circumstances, graphical user input and applications graphical output may be communicated between computing device 120 and servers 130 and/or 160. According to embodiments of the present invention, display data may be exchanged between servers 130 and 160 and computing device 120. More specifically, applications 132 and 162 may exchange display data with computing device 120. Such display data may comprise any information rendered on screen or physical display 110 as a result of an execution of applications 132 and 162 and as a result of a user interaction with applications 132 and 162.

Generally, display data communicated may comprise any information related to graphical events associated with screen or physical display 110. Display data may comprise data or information produced by applications 132 and 162 as well as information related to input from a user operating computing device 120. For example, display data may comprise graphical or other output from applications 132 and 162, e.g., graphical user interface (GUI) objects such as dialog boxes, informative windows or any other graphical or other displayable information such as plain text. Display data may also comprise user input information, e.g., mouse or other point and click device movements and clicks, keyboard key strokes or any other input information that may be produced by, on behalf, or as a result of user interaction by operating any applicable input device.

According to embodiments of the present invention, the display data may be captured on a remote application server, e.g., remote application server 160. According to embodiments of the present invention, screen capture modules 131 and 161 may capture display data communicated between computing device 120 and servers 130 and 160 respectively. Screen capture module 131 may capture any displayable output produced by application 132 and may also capture any displayable input received from a user operating computing device 120 and interacting with application 132 while screen capture module 161 may do the same with regards to application 162. For example, screen capture module 131 may be or may load into a memory of server 130, a screen capture process. Such screen capture process or module may be associated with applications such as application 132 and may receive or otherwise obtain any display data associated with an associated application.

A screen capture module or process may obtain display data or information associated with an application and a user by various means. For example, screen capture module 131 may interact or register with application 132 and receive from application 132 such display data. Alternatively, a screen capture module may interact or register with an operating system operating the local computing device and receive such display information or data. Other exemplary ways by which a module such as screen capture modules 131 or 161 may obtain screen or display data may be by extracting such data from lower levels. For example, screen capture module 161 may interact with a network interface card (NIC) or a NIC driver, receive or obtain ingress and/or egress network packets and extract display data and information from such packets. It will be realized that the any method, software, firmware, hardware or a combination thereof used for capturing display data and/or display information on remote computing devices such as servers 130 and 160 may be used without departing from the scope of the present invention.

In some cases, a screen capture process or module, e.g. display data capture module 131, may only have access to information related to the applications associated with the computing device it is executing on. For example, display data capture module 131 may only have access to display data associated with applications executed on remote application server 130, likewise, module 161 may only have access to display data associated with applications executed on remote application server 160.

According to embodiments of the present invention, screen capture module 131 may be provided with a session or application screen object representing the relevant portion of a remote display. For example, screen capture module 131 may be provided with an address to a local memory location storing screen information representing information displayed by application 132 on remote screen or physical display 110. Screen capture module 131 may divide such session or application screen or window to rectangles and may periodically scan each rectangle searching for a change that occurred since the previous scan. If a change is detected, screen capture module 131 may obtain a snapshot of the relevant rectangle, and send the snapshot information to recording server 140 and/or store the snapshot information, for example, in storage 135. For example, if a real time monitoring of screen or physical display 110 is to be performed then screen capture module 131 may continuously provide display information obtained as described herein, alternatively or additionally, screen capture module 131 may store obtained display information, for example, on storage device 135 and may further provide stored display data or information at a later time.

As described herein, screen capture modules 131 and 161 may obtain display data and display information related to applications, processes, procedures or programs executed on their respective servers. However, screen capture modules 131 and 161 may be unaware of any other applications displaying information on screen or physical display 110. For example, screen capture module 131 may be unaware of application 162 also displaying information on screen or physical display 110. Moreover, application 132 may be represented by a display window rendered on screen or physical display 110, such window may only occupy a portion of screen or physical display 110, screen capture module 131 may be unaware of the relative location of such window on screen or physical display 110, the size of the window or various other aspects related to the rendering of one or more display windows associated with application 132. For example, other graphical objects rendered on screen or physical screen or physical display 110 may partially or totally cover or obscure a specific graphical object or display window captured by capture module 131.

According to embodiments of the present invention, layout data module 123 may collect, capture or otherwise obtain any layout data or metadata related to any display windows or other graphical objects rendered on screen or physical display 110. For example, module 123 may obtain and/or record the z-order of all graphical objects rendered on screen or physical display 110, e.g., determine the object which is top most and the order of some or all other objects that follow, the size of graphical objects rendered on screen or physical display 110, the position, and other parameters. Such exemplary parameters may include the state of windows, e.g., whether a window or graphical box is in full screen mode, minimized mode or only covering a portion of screen or physical display 110, whether the graphical object, e.g., a window is selected by the user, e.g., in focus. According to embodiments of the present invention, module 123 may obtain any layout data required in order to reproduce, reconstruct or replay a presentation of display data on, or a display session of, screen or physical display 110 either in real time by continuously providing such layout data to a computing device performing such real time replay or monitoring, or at a later stage, by providing such layout data to a recording server or by storing such layout data, for example on storage device 125 and providing it on demand.

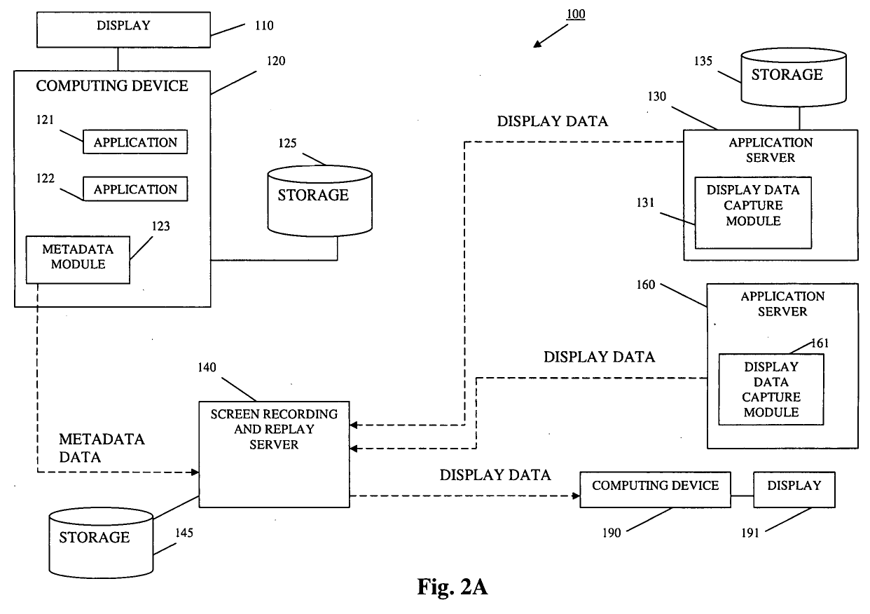

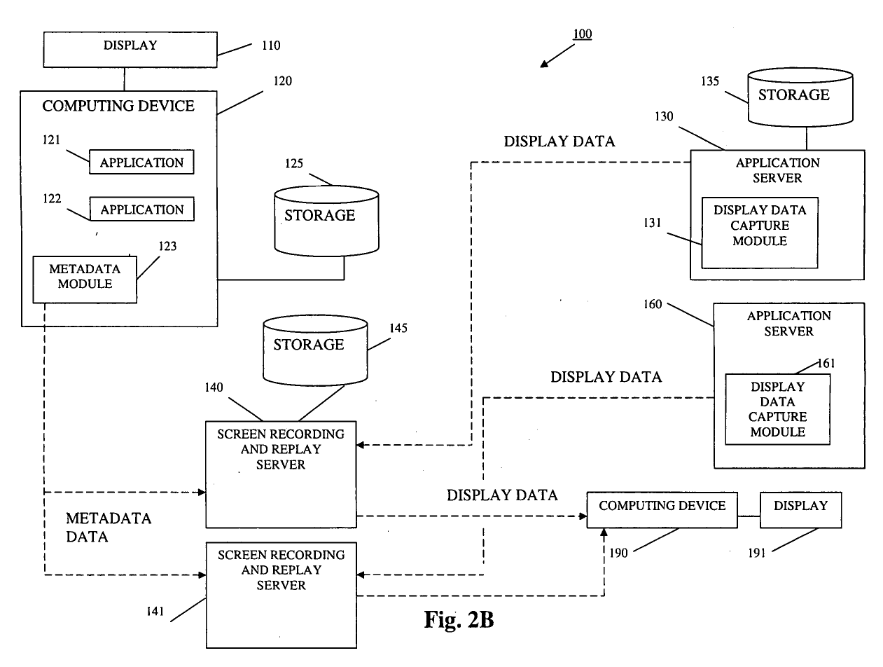

Reference is made to FIG. 2A, showing a high-level block diagram of exemplary system 100 according to embodiments of the present invention.

While some exemplary components of system 100 shown in FIG. 1 are also shown in FIG. 2A, additional exemplary components reflecting additional exemplary features according to embodiments of the invention are shown in FIG. 2A. FIG. 1 illustrates, among other things, data streaming between the computing device, such as a thin client device and the remote application servers. FIG. 2A further illustrates among other things, data streaming to the recording server. As shown, system 100 may comprise computing device 190 and associated display 191. Computing device 190 may be any applicable computing device similar to server 130, recording server 140 or computing device 120 and may comprise elements and components of a computing device 400 described with reference to FIG. 4. According to embodiments of the invention, computing device 190 may be used to replay or reconstruct a recorded presentation of display data on, or a display session of, screen or physical display 110 or monitor, in real time, an ongoing display session related to screen or physical display 110. According to embodiments of the invention, display data may be sent from remote application servers 130 and 160 to recording server 140. The display data may comprise any data or information captured or obtained by screen capture modules 131 and 161 as described herein. As shown, layout data obtained by module 123 may be sent to recording server 140.

According to embodiments of the invention, data sent from remote application servers 130 and 160 to recording server 140 may comprise any data or information captured or obtained by screen capture modules 131 and 161 or it may be a result of processing applied to such data. For example, data captured by screen capture module 131 may be filtered to reduce redundant elements. In another example, identical and consecutive screen shots may be removed, or deltas may be computed based on display data received, and only such delta information may be communicated to recording server 140. Other examples of possible processing that may be applied to captured display data before sending processed display data to recording server 140 may be encrypting and/or compressing the display data, display information or any other parameters thus communicated. Display data sent, e.g., from remote application servers 130 and/or 160 to server 140 may be sent by the module or entity that captures the display data, e.g., capture modules 131 and/or 161 or it may be sent by another module or entity, e.g., a module (not shown) that may receive captured data from modules 131 and/or 161, processes the data and then sends it to server 140.

Recording server 140 may store display data received from screen capture modules 131 and/or 161 Recording server 140 may store received data as separate information object. For example, a stream of display data received from screen capture module 131 may be saved as a first file and a stream of display data received from screen capture module 161 may be saved as a second file while associated layout data received from module 123 may be saved in a third file. Accordingly, upon demand, or when a reconstruction or replay of a presentation of display data on, or a display session of screen or physical display 110 is otherwise required, recording server 140 may incorporate the three above mentioned files into a single display data stream and either display or render information in such stream on an attached display or provide such stream to another computing device for display. According to other embodiments of the invention, recording server 140 may merge display data received with received layout data and may store the result of such merge as a single display data stream that may be provided and used at a later stage for replaying the associated display session of screen or physical display 110.

According to other embodiments of the invention, recording and monitoring server 140 may enable real-time monitoring of screen or physical display 110. According to embodiments of the invention, recording server 140 may receive display data from screen capture modules 131 and 161 and layout data from module 123 as described herein and may further use such received data to produce a single display data stream that may include information from all above sources and may further provide such stream to a computing device attached to a display, e.g., to computing device 190 as shown. The receiving device, e.g., device 191, may use such stream to provide a real-time monitoring of screen or physical display 110. In such cases, embodiments of the invention may present to a user any graphical event associated with a monitored display. Any graphical or other information displayed on a monitored display (e.g., screen or physical display 110) may be presented, in real time, on a monitoring display (e.g., display 191). For example, graphical or other information displayed on screen or physical display 110 by application 132 and any graphical information produced by a user interacting with computing device 120, e.g., mouse moves or clicks, keyboard strokes may all be presented, in real time, on monitoring display 191.

Computing device 190 may use information in such stream, for example, information captured by screen capture module 161 to render application output and/or associated user input and may further use layout data in such stream in order to accurately render graphical objects according to their arrangement, position, size, z-order, state or any other relevant parameters related to a display session on screen or physical display 110. For example, determine and implement the z-order of a number of display windows, their size, location on screen or display, state etc.

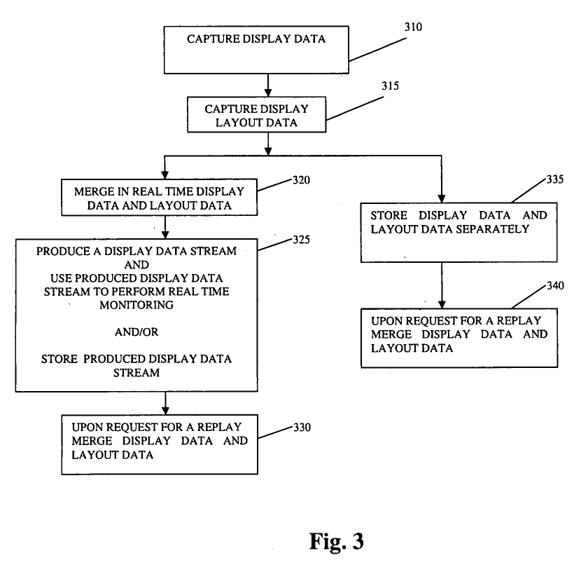

Reference is made to FIG. 3, showing a flowchart diagram illustrating an exemplary flow according to some embodiments of the present invention. As shown by block 310, the flow may include capturing display data, for example by a remote application server, as described herein with reference to screen capture modules 131 and 161. Display data associated with a local display (e.g., screen or physical display 110) may be captured by a number of remote computing devices, e.g., application servers 130 and 160. Captured data may be stored and forwarded at a later time or may be forwarded in real time, upon capture. As shown by block 315, the flow may include capturing layout data, for example in the form of metadata. In some embodiments of the invention, layout or other metadata may be captured on the computing device connected to the display being monitored or recorded. For example, module 123 may locally capture layout data related to local screen or physical display 110. As described herein, layout data may comprise information related to an arrangement, size, z-order, state or other parameters associated with graphical images or objects rendered on a display. Layout data may comprise data associated with inter relations of a number of graphical objects rendered on a given display. For example, layout data may include information such as which graphical object is the top most, which graphical object is partially or entirely covered or obscured by other objects, which graphical object has been selected by a user, which graphical object is “in focus”, etc. Captured layout data may be stored and forwarded at a later time or stage or may be forwarded in real time upon capture.

If real-time monitoring is not required, the flow may comprise storing of captured display data and layout data as shown by block 335. For example, server 140 may store captured display data and captured layout data and provide such stored data at a later time, upon request for a replay of a display session as shown by block 340. Although not shown, storing of display data and layout data as shown by block 335 may be performed in various ways. For example, display data and layout data may be merged to produce a display stream that may be readily used for replaying a display session and such stream may be stored. Alternatively, display data and layout data may be stored separately and merged at a later time, by server 140, by a replay server or by an intermediary entity.

As shown by block 320, layout data and display data may be merged, in real time. For example, data from screen capture modules 131, 161 and 123 may be received by server 140 in real time, upon being captured by modules 131, 161 and 123 and may further be combined or merged, in real time, into a single display stream usable for monitoring a display session. Monitoring a display may comprise rendering, on a first (monitoring) display, any data or information rendered on a second (monitored) display. According to embodiments of the present invention, such combined or merged display data and layout data may be used to produce a display data stream as shown by block 325. Such display data stream may be used for real-time monitoring of a monitored display. Alternatively, as shown by block 325, the stream may be stored for future use. As shown by block 330, a stored display data stream may be used, upon request to recreate or replay a display session.

According to embodiments of the invention, different or separate display data objects may be created during different time periods and may be merged or combined into a single display stream or other object usable for reconstructing a presentation of a display session. For example, display data capture module 131 may capture display data during a time period that may only partially overlap a period during which display data capture module 161 may capture display data. A reconstruction of a display session, e.g., by server 140 may take such capture time differences into account. For example, a reconstruction of a display session generated may be for the time period during which data was captured by two or more capturing entities. Merging information from a number of sources may further comprise synchronizing the different information objects in time and further generating a display data stream associated with a time period when information from such number of sources is available and synchronized.

For example, display data capture module 131 may capture display data related to display 110 from 10:00 AM until 11:05 AM while display data capture module 161 may capture display data related to display 110 from 10:10 AM until 10:45 AM and module 123 may capture layout or metadata from 09:45 AM until 11:45 AM. Accordingly, server 140 or any other suitable device may synchronize in time the captured data produced and/or provided by modules 131, 161 and 123 and produce a display stream usable for reconstructing or presenting a display session of display 110 related to 10:10 AM to 10:45, a time period when relevant information from all sources is available.

Other time synchronization issues may be addressed by embodiments of the invention. For example, clocks of computing device 120 and application servers 130 and/or 160 may not be synchronized. This may be due to various reasons, e.g., an internal clock, possibly governed by a chip or crystal, of server 130 may be faster or slower than the clock of server 160 or an administrator may alter the system time of application server 160 but fail to similarly apply such alteration to server 130 or the administrator may set the clocks of servers 130 and 160 to different times. However, regardless of the internal, local or other clock or time mechanism related to one or more computing devices in system 100, embodiments of the invention may maintain time synchronization of display data sources and layout data in a number of ways or methods. For example, computing device 120 or one of servers 130, 160 or 140 may periodically send a beacon, heart beat or any other message to some or all other computing devices in the system. Such message may contain any relevant or required parameters or information that may enable a receiving computing device to accurately synchronize its time, clock or any suitable component, parameter or relevant object according to information or parameters in the received message. Such mechanism may maintain a common and/or synchronized time and/or clock for some or all computing devices and/or servers included system 100.

According to other embodiments of the invention, a time stamp or other information or parameter may be associated with and/or attached to packets or other information or data objects communicated between computing devices in system 100. For example, a time stamp may be attached to some or all display data packets communicated from computing device 120 to application servers 130 and/or 160. Accordingly, data captured by display data capture modules 131 and 161 may be associated with time information, e.g., packets stored and/or sent by modules 131 and 161 to screen recording server 140 may contain or be otherwise associated with time information, e.g., a time stamp. Additionally, data captured by metadata module 123 may be associated with time, timing or synchronizing data, information or parameters as described herein. Such timing or synchronizing information or parameters associated with display data, layout data or any other data, parameters or information may be used, for example by server 140, in order to synchronize multiple sources of display or layout data. For example, server 140 may synchronize display data received from application servers 130 and 160 and lay out data received from computing device 120 regardless of their respective clocks or time

According to other embodiments of the invention, instead or in addition to a time stamp as described herein, a time difference or delta may be attached or otherwise associated with data packets or other information objects. For example, information indicating the time difference from a previous or other reference packet or object may be associated with communicated packets or information objects. For example, possibly after some scheme or mechanism for an initial synchronization is followed, display data packets communicated from computing device 120 to servers 130 and 160 as described herein may contain or be otherwise associated with information or parameter that indicates a time difference from a previous packet or from any other known event in time. For example, a known event in time may be a predefined synchronization message that may be periodically sent. Accordingly, subsequent display data packets or any other information objects may contain a time difference information or delta information related to the time such synchronization message was sent and/or received. It will be recognized that any method, mechanism, algorithm ways or means for synchronizing information pr data such as display or layout data may be utilized without departing from the scope of the present invention.

Reference is made to FIG. 2B, showing a high-level block diagram of exemplary system 100 according to embodiments of the present invention. While some exemplary components of system 100 shown in FIG. 1 and FIG. 2A are also shown in FIG. 2B, additional exemplary components reflecting additional exemplary features according to embodiments of the invention are shown in FIG. 2B. As shown by block 141, system 100 may comprise more than a single screen recording and replay server, e.g., screen recording and replay servers 140 and 141.

According to embodiments of the invention, two or more recording and/or playback servers may receive display data and/or layout data from a number of sources. Such number of recording servers may collaborate in producing a display stream usable for reconstructing a presentation of display data on a display screen, e.g., display screen 110. For example, two or more recording servers may receive layout data from a computing device coupled to a display screen and may further each receive display data from separate sources. For example, as shown by FIG. 2B, server 140 may receive layout data from computing device 120, e.g., from metadata module 123 and may further receive display data from remote application server 130, e.g., from display data captured by module 131. Server 141 may receive layout data similarly to server 140 and further receive display data from remote application server 160, e.g., from display data captured by module 161.

According to embodiments of the invention, two or more recording and/or playback servers may provide layout and display data to a computing device, e.g., a playback server that may further combine such input into a display stream usable for reconstructing a presentation of display data on a display screen or the playback server may use such input received from a number of recording servers to render information on an attached display thus cause a replay, possibly in real time of a display session associated with the source display screen. For example, servers 140 and 141 may each provide computing device 1 00 with layout data and display data received respectively from computing device 120, application server 130 and application server 160. Computing device, possibly in a capacity of a replay server may combine, merge or otherwise use such data to reproduce, reconstruct or otherwise cause any visual effects presented on display 110 on display 191.

As described herein a clock or other time parameters difference may exist, for example between servers 140 and 141. Any mechanism, paradigm or other methods described herein aimed at overcoming such time synchronization issues may be applied to overcome time synchronization issues that may be observed with relation to multiple recording server acting in a capacity described herein. For example, any of: a time stamp or tag, delta or other difference information or any other time synchronization parameter attached or otherwise associated with display or layout data as described herein and received to servers 140 and 141 may be communicated to computing device 190 and may be used, for example by computing device 190, for synchronizing display data and layout data received from servers 140 and 141. Other methods or means for synchronizing display and/or layout information may comprise a synchronization of clocks or other time mechanisms of the relevant recording servers. For example, the clocks of servers 140 and 141 may be synchronized, e.g., by having servers 140 and 141 exchange a synchronizing message, possibly periodically or otherwise or by having another entity, possibly external to both server 140 and 141 dictate or otherwise control any applicable time parameter of servers 140 and 141.

Reference is made to FIG. 4, showing high level block diagram of an exemplary computing device according to embodiments of the present invention. According to embodiments of the invention, computing devices 120 and 190, remote application servers 130 and 160 and recording server 140 may comprise all or some of the components comprised in computing device 400 as shown and described herein. According to embodiments of the invention, computing device 400 may include a memory 430, controller, e.g., central processing unit processor (CPU) 405, monitor or display 425, storage device 440, an operating system 415, input device(s) 420 and output device(s) 445.

According to embodiments of the invention, storage device 440 may be any suitable storage device, e.g., a hard disk or a universal serial bus (USB) storage device, input devices 420 may include a mouse, a keyboard or any suitable input devices and output devices 445 may include one or more displays, speakers an/or any other suitable output devices. According to embodiments of the invention, various programs, applications, scripts or any executable code may be loaded into memory 430 and may further be executed by controller 405. For example, screen capture module 131 described herein may be loaded into memory 430 and may be executed by controller 405 under operating system 415. Similarly, exemplary applications 121 and 122 or layout data module 123 may be loaded into memory 430 of computing device 400 and executed as described herein, for example with reference to FIG. 1 and FIG. 2A.

Some embodiments of the present invention may be implemented in software for execution by a processor-based system, for example, recording server 140 and servers 130 or 160 or computing devices 120 and 190. For example, embodiments of the invention may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), rewritable compact disk (CD-RW), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices. Other implementations of embodiments of the invention may comprise dedicated, custom, custom made or off the shelf hardware, firmware or a combination thereof. For example, a hardware card installed on server 140 may perform the task of merging a number of display data streams into a single display data stream.

Such system may include components such as, but not limited to, a plurality of central processing units (CPU) or any other suitable multi-purpose or specific processors or controllers, a plurality of input units, a plurality of output units, a plurality of memory units, and a plurality of storage units. Such system may additionally include other suitable hardware components and/or software components.

For example, recording server 140 and servers 130 or 160 or computing devices 120 and 190 may be or may comprise a processor-based system comprising a controller or processor and code that may be stored on an attached storage medium and may execute and perform functions as described herein, e.g., functions described with reference to screen capture modules 131 and 161 or functions described with reference to layout data module 123.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method for recording screen data, the method comprising:
displaying display data displayed on a screen coupled to a local computing device wherein the display data is associated with first and second applications executed on first and second remote application servers;
capturing, by the first remote application server a first portion of the display data associated with the first application;
capturing, by the second remote computing device a second portion of the display data associated with the second application; and
capturing, by the local computational device layout data related to a presentation of the display data on the screen;
providing the layout data and the first and second portions of the display data to a recording server;
synchronizing in time the layout data and the first and second portions of the display data to enable time-related reconstruction of the presentation; and
reconstructing visual appearance of the presentation based on the layout data and the display data.

2. The method of claim 1, comprising:
storing separately the layout data, the first portion of the display data and the second portion of the display data,
wherein reconstructing the visual appearance is performed off-line.

3. The method of claim 1, wherein reconstructing the visual appearance is performed in real-time.

4. The method of claim 1, wherein the layout data comprises at least a window position parameter, a window size parameter, a window z-order parameter, a window focus parameter or a window state parameter.

5. The method of claim 1, wherein capturing the first portion of the display data is performed by interacting a network interface card (NIC) coupled to the first remote computing device.

6. The method of claim 1, wherein capturing the first portion of the display data is performed by interacting with the first application.

7. The method of claim 1, wherein capturing the first portion of the display data is performed by interacting with an operating system of the first remote computing device.

8. A system for recording screen data, the system comprising:
a first remote application server;
a second remote application server;
a local computing device coupled to a screen, wherein display data displayed on the screen is associated with first and second applications executed on the first and second remote application servers, respectively; and
a recording server to receive the display data displayed on the screen and layout data related to a presentation of the display data on the screen for reconstructing visual appearance of the presentation based on the layout data and the display data,
wherein the local computing device captures the layout data and delivers the layout data to the recording server, the first remote application server captures a first portion of the display data associated with the first application and delivers the first portion of display data to the recording server, the second remote application server captures a second portion of the display data associated with the second application and delivers the second portion of display data to the recording server.

9. The system of claim 8, wherein the recording server synchronizes in time the display data and the layout data.

10. The system of claim 8, wherein the recording server stores the layout data and the display data and upon request produces a display stream usable to reconstruct the presentation.

11. The system of claim 8, wherein the recording server produces a display steam of the visual appearance of the presentation in real-time.

12. The system of claim 8, wherein the layout data comprises a window position parameter, a window size parameter, a window z-order parameter, a window focus parameter or a window state parameter.

13. The system of claim 8, wherein the first remote application server captures the first portion of the display data by interacting with the first application, a network interface card installed in the first remote server or an operating system operating the first remote server.
